(19) United States
(12) Patent Application Publication
(10) Pub. No.: US 2005/0038745 A1
(43) Pub. Date: Feb. 17, 2005

(54) Scheduled remittance method

(75) Inventor: Masaru Washizu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/945,872

(22) Filed: Sep. 22, 2004

Related U.S. Application Data
(63) Continuation of application No. PCT/JP02/03153, filed on Mar. 29, 2002.

(51) Int. Cl. G06F 17/60

(52) U.S. Cl. 705/42

(57) ABSTRACT

A remittance scheduling program (1323) executed on an on-line banking server (13) instructs a host (15) to store a scheduled remittance record representing remittance a predetermined amount of money to a predetermined remittee account on a predetermined remittance date according to the information entered by a user in a database (15) and subtracts the predetermined amount from the withdrawable balance in the account balance record of the bank account of the user. A scheduled remittance management program (1522) on the host (15) remits the predetermined amount to the predetermined remittee account on the predetermined remittance date according to the scheduled remittance record stored in the database (153).

### FIELD OF THE INVENTION

The present invention relates to a scheduled remittance method for keeping a deposit with a contract in a financial institute (a bank) before the deposit is actually transmitted and relates to a scheduled remittance program for managing a deposit in a system of a financial institute.

### BACKGROUND OF THE INVENTION

In trade of service or a product between a user and a service provider or a commodity seller through a network, a mail or a telephone, service or a commodity to be traded may not be delivered immediately (because, for example, the service will carry out on a predetermined data and time in feature, the commodity is out of stock, or the commodity is constructing). In such a case, a predetermined term may be arranged between the conclusion of a contract and implementation thereof.

In general, a service provider or a commodity seller requires temporary advance of a deposit as a credit guarantee for user's solvency at the time of the conclusion of a contract. In trade of service or a product between a user and a service provider or a commodity seller through a network, a mail or a telephone as described above, temporary advance of a deposit is executed by remittance from a bank account of a user to that of a service provider or a commodity seller. For example, for a travel tour, remittance of charge in part or in all from a user to a bank account of a travel agent will be a prerequisite of a conclusion of a contract, and when conditions for enforcement of the tour are satisfied, for example, satisfaction of the minimum required number of people, the contract can be implemented, then the user remits a remainder to the bank account of the travel agent.

However, the remittance of the money to a service provider or a commodity seller before an implementation of the contract causes various kinds of inconvenience. One kind of inconvenience is that remittance charges by a bank are charged twice when a provision of a service or sale of a commodity becomes impossible. In such a case, since the deposit is refunded to the user's account, the deposit is unnecessarily remitted twice. For example, for the above-described travel tour, the deposit is returned from the bank account of the travel agency to the bank account of the user when the conditions for enforcement of the tour are not satisfied. In such a case, the user pays the remittance charges for the double remittance that are unnecessary as a result, in general.

A second inconvenience is that the interest on the deposit is paid to the bank account of the service provider of the commodity seller because the deposit is temporally added to the account of the service provider of the commodity seller, even though they have no right because the contract is assumed to be void from the beginning when the contract is canceled.

On the other hand, if law prohibits payment of deposit, it facilitates a rapid order for a provision of a service or sale of a commodity and a rapid cancel thereof, which puts too much load on the service provider or a commodity seller.

The present invention is accomplished with considering these problems and the object of the invention is to provide a scheduled remittance method that stops remittance from a bank account of a user to a bank account of a service provider or a commodity seller within a term from a conclusion of a contract to implementation thereof to avoid the above-described inconveniences, and freezes the equivalent to the deposit in the user's bank account, and then remits a deposit to the bank account of the service provider or the commodity seller after a lapse of the term to guarantee a credit of the user's solvency. The present invention also aims to provide a scheduled remittance management program that can execute the above scheduled remittance method on a host computer in a bank system.

### DISCLOSURE OF THE INVENTION

According to the scheduled remittance method of the present invention that is accomplished to solve the above problems, a disk device stores account balance records, each of which includes at least an ID of the account, balance of the account and withdrawable balance indicating an amount of money that can be withdrawn by an account holder, to manage the respective accounts. When money is withdrawn from the account at the request of the account holder, the amount of withdrawn money is subtracted from the balance and is subtracted from the withdrawable balance in the account balance record corresponding to the account. When money is added to the account, the amount of added money is added to the balance and the withdrawable balance in the account balance record about the account. Add to this, a remittance schedule record, which consists of an ID of a remitter account, a scheduled remittance date, an amount of remittance and an ID of a remittee account, is stored in the disk device at a request of a remitter, then a processing device executes a scheduling process to subtract the amount of remittance from the withdrawable balance in the account balance record corresponding to the remitter account. The processing device further executes a remittance process to subtract the amount of remittance from the balance in the account balance record corresponding to the remitter account to remit the amount of the remittance to the remittee account based on the remittance schedule record whose remittance date matches the processing date.

In addition, the processing device executing the scheduling process and the processing device executing remittance process may be common or may be separate devices. Further, the processing devices executing the scheduling process and the remittance process may be a physically single device or a plurality of devices that are physically dispersed.

Still further, the scheduled remittance management program of the present invention makes the computer that is connected with a disk device storing account balance records, each of which includes at least an ID of the account, balance of the account and withdrawable balance indicating an amount of money that can be withdrawn by an account holder, to manage the respective accounts, stores the remittance schedule record, which consists of an ID of a remitter account, a scheduled remittance date, an amount of remittance and an ID of a remittee account, into the disk device at a request of a remitter, execute a scheduling process to subtract the amount of remittance from the withdrawable balance in the account balance record corresponding to the remitter account, and execute the remittance process to subtract the amount of remittance from the balance in the account balance record corresponding to the remitter account to remit the amount of the remittance to the remittee account based on the remittance schedule record whose remittance date matches the processing date.

In addition, the computer executing the scheduling process and the computer executing remittance process may be common or may be separate devices. Further, the computers executing the scheduling process and the remittance process may be a physically single processing device or a plurality of processing devices that are physically dispersed.

According to the invention constructed above, the balance is equal to the withdrawable balance in the account balance record corresponding to the remitter account of the account holder who wants to remit before the schedule remittance record is stored in the disk device at the request of the account holder. The balance and the withdrawable balance decrease at the same time when money is withdrawn from the account, and they increase at the same time when money is added to the account. As opposed to this, the amount of the remittance in the schedule remittance record is subtracted from the withdrawable balance in the account balance record corresponding to the remitter account of the account holder who wants to remit after the schedule remittance record is stored in the disk device at the request of the account holder. After that, the amount within the withdrawable balance can be only withdrawn from the remitter account of the account holder who wants to remit. That is, when the balance is equal to the amount of remittance, even an account holder of the account cannot withdraw money from the account. Then, the amount of remittance is subtracted from the balance in the account balance record corresponding to the remitter account on the scheduled remittance date in the remittance schedule record, and the process for remitting the amount of remittance to the remittee account is executed. In this way, according to the present invention, since money is not remitted actually in a term from the time of the execution of the scheduling process to the time of the execution of the remittance process, if the contract corresponding to the remittance is canceled, it is unnecessary to refund money from the remittee account to the remitter account, which avoids unreason of unnecessary double remittance and avoids unreason of adding interest to the remittee account during the term. Further, the money kept as the amount of remittance cannot be withdrawn even by the remitter and is kept for the remittance to the remittee account on the scheduled remittance date, which becomes a credit guarantee of the remitter.

In the present invention, the remittance schedule record may be only void by the request of the account holder of the remittee account in the remittance schedule record, and the processing device may execute the canceling process to add the amount of remittance in the remittance schedule record to the withdrawable balance in the account balance record corresponding to the ID of the remitter account in the remittance schedule record. In such a case, the remitter cannot cancel the scheduled remittance of the person's own way, which further enhances the function of the credit guarantee of the remitter. In addition, the void of the remittance schedule record is a concept including an deletion of the remittance schedule record itself.

Further, in the present invention, the processing device may inform the contents of the remittance schedule record to the account holder of the remittee account at the time of the scheduling process. In such a case, the account holder of the remittee account certainly knows the presence of the remittance schedule by the remitter, which further enhances the function of the credit guarantee of the remitter. The contents may be informed through a postal mail or an electric mail for the account holder of the remittee account or may be displayed on a monitor display or a web screen at the request of the account holder of the remittee account. In addition, when the processing device does not inform the contents of the remittance schedule record, the remitter must inform by himself or herself. In order to enhance the function of the credit guarantee, it is desirable that the processing device issues a certification for certifying the contents of the remittance schedule record.

Further, a remitter account and a remittee account in any of the remittance schedule records may be opened in the same financial institute or may be opened in different financial institutes, respectively. In the later case, the contents of the remittance schedule record may be informed from a processing device of a bank system with which the remitter account is opened to a bank system with which the remittee account is opened and may be informed to the account holder of the remittee account.

### BRIEF DESCRIPTION OF THE DRAWINGS

FIG. 1 is a block diagram of an inter-bank remittance system of a first embodiment according to the present invention.

FIG. 2 is a flowchart showing a process according to a scheduled remittance program.

FIG. 3 is a flowchart showing a process according to a remittance canceling program.

FIG. 4 is a flowchart showing a process according to a scheduled remittance management program.

FIG. 5 shows a scheduled remittance operation screen.

FIG. 6 shows contents of a remittance certification.

FIG. 7 shows an account balance record before remittance is scheduled.

FIG. 8 shows a remittance schedule record.

FIG. 9 shows the account balance record after remittance is scheduled.

FIG. 10 shows the account balance record just before the remittance.

FIG. 11 shows the account balance record just after the remittance.

FIG. 12 is a sequence chart showing a process of remittance scheduling.

FIG. 13 is a flowchart showing a process of a scheduled remittance program of the second embodiment according to the present invention.

FIG. 14 is a flowchart showing a process of a remittance canceling program of the second embodiment according to the present invention.

FIG. 15 is a flowchart showing a process of a scheduled remittance management program.

FIG. 16 shows a scheduled remittance receiving operation screen.

FIG. 17 shows a scheduled remittance telegram record.

FIG. 18 shows a scheduled remittance canceling telegram record.

FIG. 19 is a sequential chart showing a procedure of a remittance scheduling in the second embodiment according to the present invention.

### THE BEST CONFIGURATION FOR EMBODYING THE INVENTION

Hereinafter, the configurations for performing the present invention will be described based on the drawings.

### Embodiment 1

The first embodiment is a feasible example by improving a bank system with which a user opens a bank account.

(System Configuration)

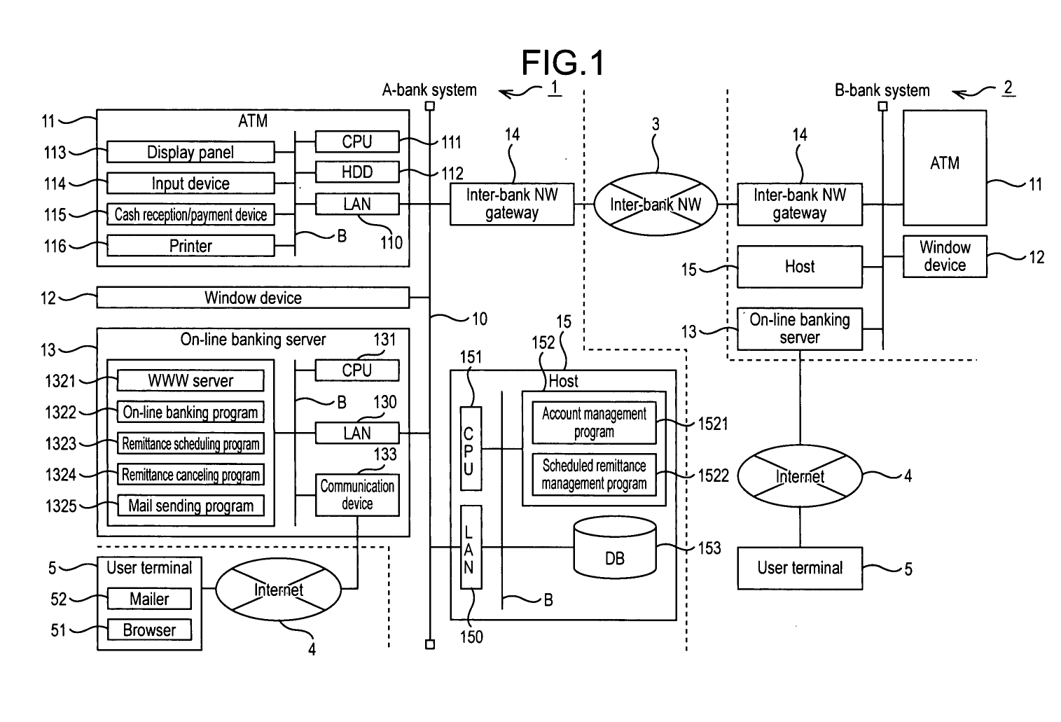

FIG. 1 is a block diagram of an inter-bank remittance system of the first embodiment. As shown in FIG. 1, the inter-bank remittance system is configured by connecting a plurality of bank systems (only an A-bank system 1 and a B-bank system 2 are illustrated) through a inter-bank network (a network consisting of private lines) 3. In FIG. 1, the A-bank system is improved for embodying the scheduled remittance method of the present invention with which users open bank accounts. In addition, a bank account of a service provider or a commodity seller as remittee may exist in the A-bank system 1 or the B-bank system 2.

The bank systems 1 and 2 are identical in a hardware configuration and a software configuration except that the A-bank system is provided with software for performing the later described scheduled remittance method (a scheduled remittance program, a remittance canceling program, a scheduled remittance management program, a remittance schedule record, and a column of a withdrawable balance in a account balance record). Therefore, the configuration of the bank system is described for the A-bank system 1 only, and the description about the common configurations except for the different points is used for describing the B-bank system 2.

The A-bank system 1 consists of a plurality of automatic teller machines (ATM) 11 (only one is illustrated in FIG. 1), a plurality of window devices 12 (only one is illustrated in FIG. 1), an on-line banking server 13, an inter-bank network gateway 14 and a host 15 that are connected to one another through a local area network (LAN) and a wide area network (WAN).

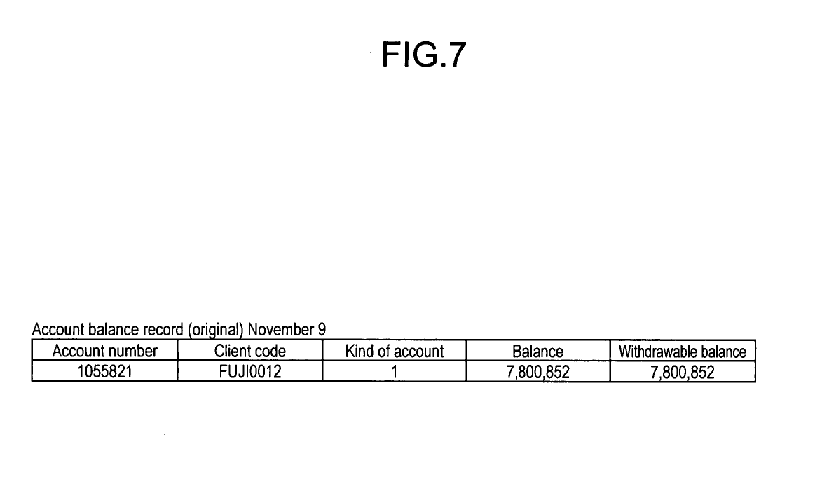

The host 15 is a computer to manage original data (data including account balance records shown in FIG. 7 and personal information such as addresses, names, telephone numbers and e-mail addresses of account holders) of bank accounts opened with respective branches of the A-bank operating the A-bank system 1.

Further, the inter-bank network gateway 14 is a communication device that becomes a gateway between a corporate network 10 and the inter-bank network 3 and controls transmission/reception of telegrams about remittance or the like.

The ATM 11 is an automatic teller machine set up in a bank or a local office thereof and enables to have dealing with the A-bank (addition, withdrawal, regular remittance, scheduled remittance or the like) in response to operations of a user (including the above-described user, and a person in charge of a service provider or a commodity seller).

The window device 12 is operated by a teller of a bank to inquire of the host 15 about balance of a user's account and to inform the host 15 about contents of trade.

The on-line banking server 13 communicates with user terminals 5 through the Internet 4 (reception of a request and transmission of a response according to the hyper text transfer protocol (HTTP), reception and transmission of e-mail according to the simple mail transfer protocol (SMTP) and the post office protocol (POP).

Hereinafter, detail configurations of the respective devices will be described.

The host 15 is provided with a LAN card 150, a CPU 151, a hard disk drive 152 and a database 153 as prime constitutions that are connected to one another through a bus. The LAN card 150 is an interface with the corporate network 10. Further, the CPU 151 is a computer as a processing device that reads various programs stored in the hard disk drive 152 to execute processes according to the programs.

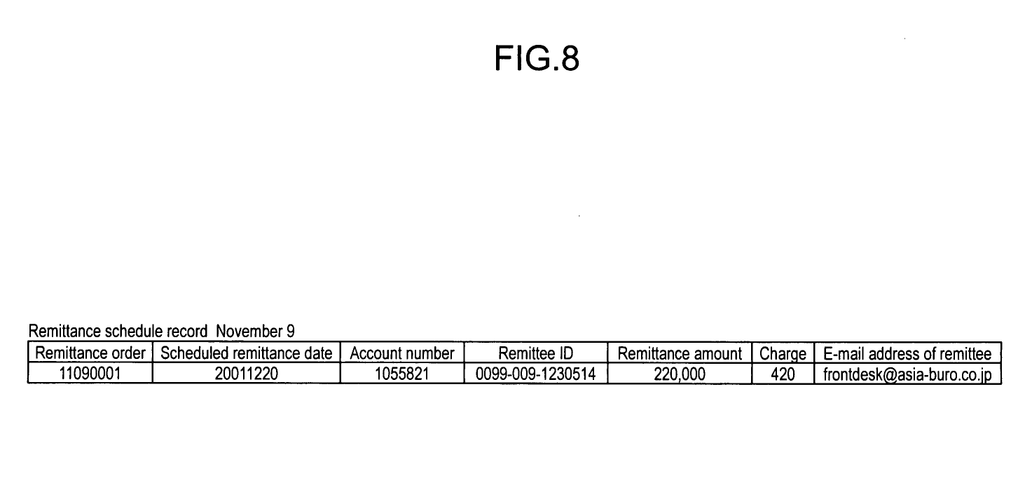

The database 153 is a disk device that stores the above described original data of the bank accounts and data (remittance schedule records shown in FIG. 8) including contents of scheduled remittance requested by the respective ATM 11, the window device 12 and the on-line banking server 13. An account balance record included in the above described original data of the bank accounts stores, as shown in FIG. 7, an account number as an ID of the bank account, a client code for identifying the account holder of the bank account, a kind of the bank account (a saving account, a checking account, or the like), a withdrawable balance indicating an amount of money that can be withdrawn by an account holder in addition to a balance of the bank account. Further, the remittance schedule record stores, as shown in FIG. 8, a remittance order that is a serial number to identify remittance schedule, a scheduled remittance date, a remitter account number (an ID of a remitter account), a remittee ID (a bank number+a branch number+an account number) to identify the remittee bank account, an amount of remittance, remittance charge, and an e-mail address of the account holder of the remittee account.

The hard disk drive 152 as a computer-readable radium stores various programs including an account management program 1521 and a scheduled remittance management program 1522 in addition to an operating system program (not shown). The account management program 1521 is a conventional program to manage the original data of the bank accounts stored in the database 153 (creation with new contracts, deletion with cancellations, increase and decrease of balances).

The scheduled remittance program stores remittance schedule records into the database 153 in response to the request from the ATM 11, the window device 12 or the on-line banking server 13, updates the withdrawable balance in the account balance record, responds the contents of the respective remittance schedule records stored in the database 153, executes the process to cancel the remittance schedule and executes the scheduled remittance whose remittance date matches the processing date.

The on-line banking server 13 consists of a LAN card 130, a CPU (central processing unit) 31, a hard disk drive 132 and a communication device 133 that are connected to one another through a bus B. The communication device 133 is an interface with a line on which the Internet N is constructed (Internet backbone depending on circumstances), and the device 133 controls the communications between the on-line banking server 13 and a user terminal 5 accessing through the Internet 4. The user terminal 5 is a conventional personal computer having the Internet connecting function. A commercially available browser program 51 and a mailer program 52 are executed on the user terminal 5.

The LAN card 150 is an interface with the corporate network 10. The CPU 131 reads respective programs stored in the hard disk drive 132 to execute processes according to the respective programs.

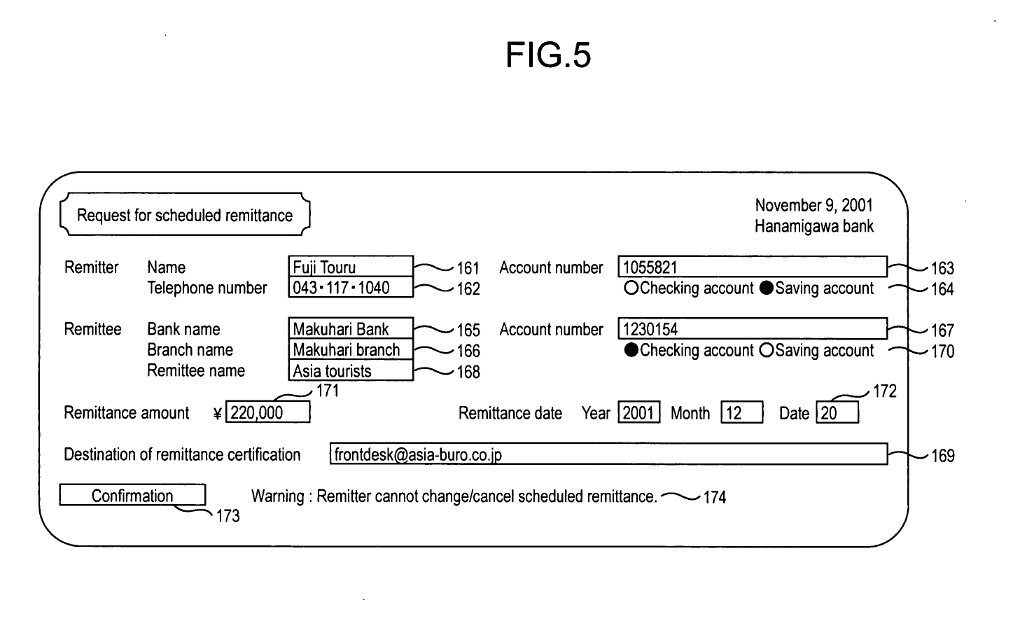

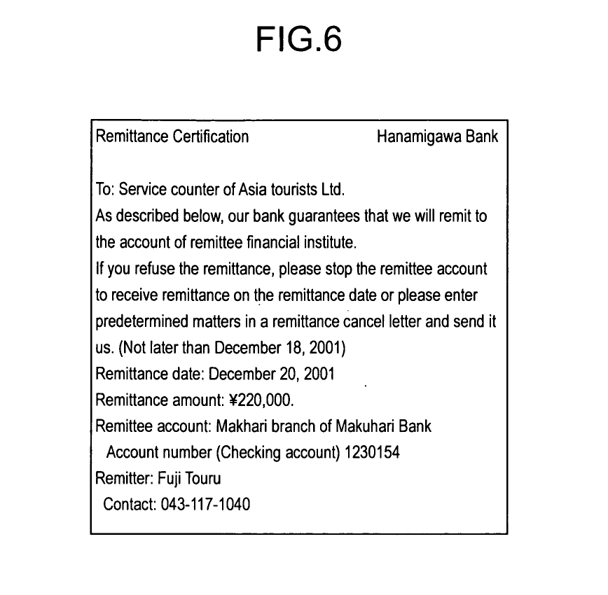

The hard disk drive 132 stores various programs that are executed by the CPU 131 and data. The data stored in the hard disk drive 132 include a hypertext markup language (HTML) data to display a scheduled remittance operation screen shown in FIG. 5, and text data with an electronic signature indicating contents of a remittance certification shown in FIG. 6. Further, the programs stored in the hard disk drive 132 includes an operating system program (not shown), a WWW (world wide web) server 1321, a mail sending program 1325, a CGI (common gateway interface) program that is started by the WWW server 1321 (start-up is instructed by the URL included in an HTTP request message received by the WWW server 1321) or an on-line banking program 1322 as a servlet, a remittance scheduling program 1323 and a remittance canceling program 1324.

The WWW server 1321 is a popular web server program to respond an HTML data corresponding to the URL designated by a HTTP request message transmitted from the browser 51 on the user terminal 5. When the URL designates any of the CGI program or the servlet, the WWW server 1321 starts the CGI or the servlet to make it execute a process designated by parameters included in the HTTP request message.

The on-line banking program 1322 is a conventional program that transmits HTML data to display various operation screens on the browser 51 of the user terminal 5 and requests that the host 15 executes a trade according to the contents of the operations entered on the operation screens.

The remittance scheduling program 1323 is a program that transmits HTML data to display a scheduled remittance operation screen as shown in FIG. 5 on the browser 51 of the user terminal 5 and transmits a new entry of the remittance schedule record to the host 15 according to the contents of the operations entered on the scheduled remittance operation screen.

The remittance canceling program 1324 is a program that requests cancellation of the scheduled remittance of the host 15 in response to a demand (a demand by an HTTP request message, an e-mail or a document) from a remittee in any of the remittance schedule records managed by the host 15.

The mail sending program 132 is a program that transmits an e-mail including demanded contents to a demanded e-mail address in response to demands from the remittance scheduling program 1323, the remittance canceling program 1324 and the scheduled remittance management program 1522 on the host 15.

The ATM 11 has a conventional hardware configuration that consists of a LAN card 110, a CPU 111, a hard disk drive 112, a display panel, an input device 114, a cash reception/payment device 115 and a printer 116 that are connected to one another through the bus B. The LAN card 110 is an interface with the corporate network 10. The CPU 111 reads respective programs stored in the hard disk drive 112 to execute processes according to the respective programs. The display panel 113 is a liquid crystal display panel to display various operation screens (the scheduled remittance operation screen shown in FIG. 5, for example) under the control of the CPU 111. The input device 114 has a transparent touch panel attached on the display panel 113. The input device 114 interprets information input by the touch panel and inputs it to the CPU 111. The cash reception/payment device 115 receives cash inserted by a user and it outputs cash directed to withdraw under the control of the CPU 111. The printer 116 prints records of trade through the ATM 111 on a user's bankbook and prints records of trade on a roll paper under the control of the CPU 111. In addition, the printer 116 has an additional function to print a remittance certification shown in FIG. 6 on a roll paper, which is an improvement to execute the scheduled remittance of the present invention.

Various programs stored in the hard disk drive 112 include a conventional control program to serve conventional functions of the ATM 11 and programs that make the CPU 111 execute processes equivalent to the above described remittance scheduling program 1323 and the remittance canceling program 1324. In addition, each program executed on the ATM 11 is started by selecting from a menu screen (not shown) that is displayed on the display panel 113. Further, each screen is displayed on the display panel 113 based on image data stored in the hard disk drive 112.

(Contents of Process)

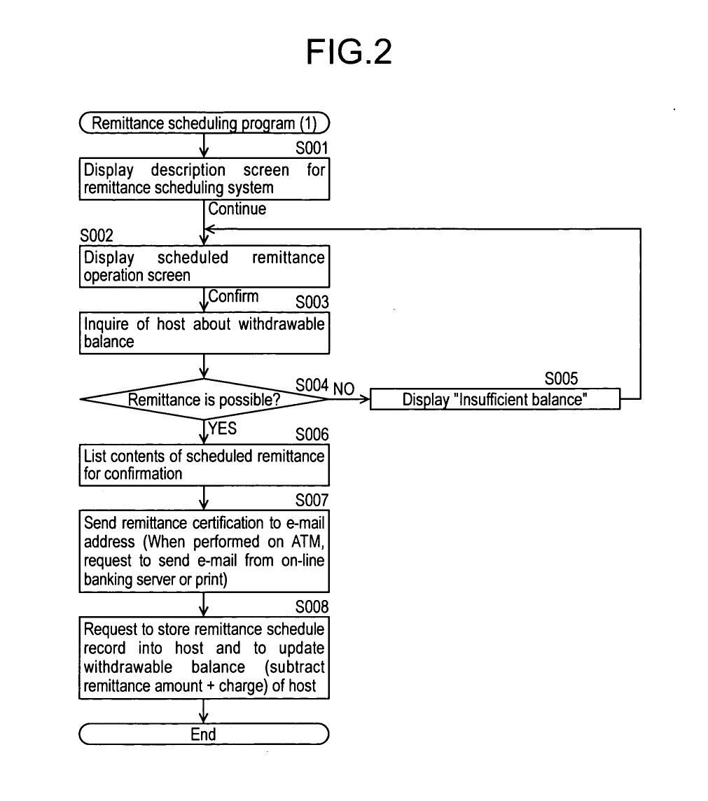

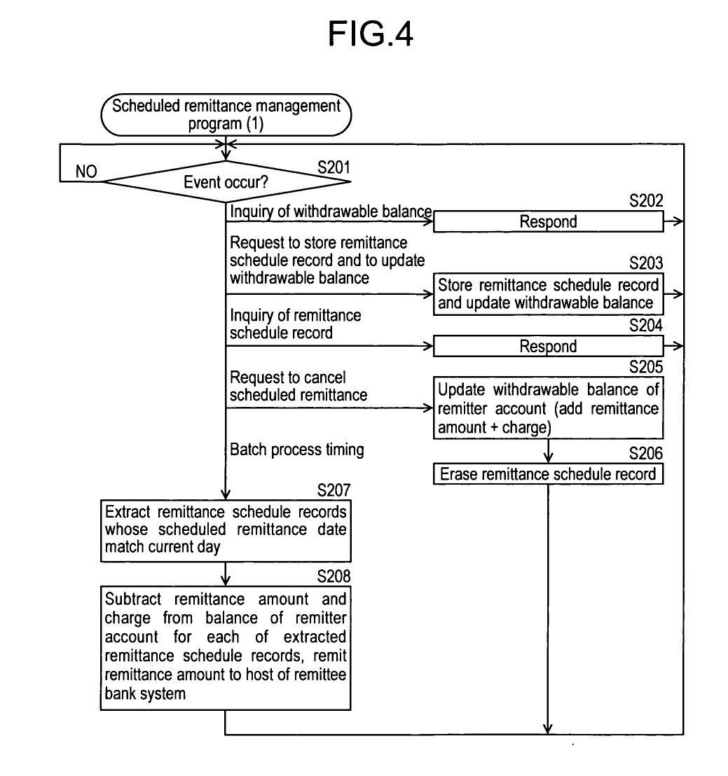

Next, the contents of the remittance scheduling program 1323 and the remittance canceling program 1324 in the on-line banking server 13 that is added to the A-bank system 1 to perform the scheduled remittance method in the first embodiment of the present invention, and the scheduled remittance management program 1522 in the host 15 will be described in order based on the respective flowcharts shown in FIG. 2 though FIG. 4.

<Remittance Scheduling Program>

The remittance scheduling program 1323 in the on-line banking server 13 is started when an HTTP request message from the browser 51 of the user terminal 5 specifies the URL of itself. At a first step S001 after the startup, the remittance scheduling program 1323 (the CPU 131 that executes the program) sends HTML data for displaying a description screen for the remittance scheduling system on the browser 51 to the user terminal 5.

At the next step S002, the remittance scheduling program 1323 sends HTML data for displaying the scheduled remittance operation screen shown in FIG. 5 to the user terminal 5. In addition, the scheduled remittance operation screen includes a “name” column 161, a “telephone” column 162 and an “account number” column 163 for inputting a name, a telephone number and an account number of a remitter of the scheduled remittance, respectively, an option button 164 for selecting a kind of the remitter account, a “bank name” column 165, a “branch name” column 166, an “account number” column 167, a “remittee name” column 168 and a “destination of remittance certification” column 169 for inputting a bank name, a branch name, an account number, an account name and an e-mail address of a remittee, respectively, an option button 170 for selecting a kind of the remittee account, a “remittance amount” column 171 for inputting remittance amount, a “scheduled remittance date” column 172 for inputting a scheduled remittance date, and a “confirmation” button 173. Further, the warning “Remitter cannot change/cancel scheduled remittance” is displayed on the scheduled remittance operation screen. In addition, the “confirmation” button 173 is available only when the necessary information is input into all the columns in the scheduled remittance operation screen. When the operator of the user terminal 5 clicks the “confirmation” button 173 after inputting the necessary information into all the columns in the scheduled remittance operation screen, the browser 51 sends an HTTP request message with the contents input into the respective column as arguments to the remittance scheduling program 1323. Then, the remittance scheduling program 1323 advances the process to S003.

At S003, the remittance scheduling program 1323 inquires of the host 15 about the withdrawable balance in the account balance record corresponding to the remitter's account number included in the HTTP request message received at S002. Receiving the response to the inquiry from the host 15, the remittance scheduling program 1323 advances the process to S004.

At S004, the remittance scheduling program 1323 checks whether the withdrawable balance responded from the host 15 is higher than the remittance amount included in the HTTP request message received at S002. If the withdrawable balance is less than the remittance amount, the remittance scheduling program 1323 determines that the remittance is impossible and sends HTML data for displaying “insufficient balance” on the browser to the user terminal 5 at S005. In this case, the operator of the user terminal 5 can click a “back” button (not shown) on the frame of the browser 51 to display the scheduled remittance operation screen again. This returns the process to S002.

On the other hand, when the withdrawable balance is more than the remittance amount, the remittance scheduling program 1323 creates HTML data for displaying a confirmation screen, which lists the contents of the scheduled remittance included in the HTTP request message received at S002, on the browser 51, and sends it to the user terminal 5 at S006.

At the next step S007, the remittance scheduling program 1323 requests that the mail sending program 1225 sends an e-mail, which has a text file of the remittance certification shown in FIG. 6 with the electronic signature, to an e-mail address included in the HTTP request message received at S002.

At the next step S008, the remittance scheduling program 1323 informs the information included in the HTTP request message received at S002 to the host 15 and requests to store a remittance schedule record and to update the withdrawable balance in the account balance record corresponding to the bank account of the remitter. After finishing a process at S008, the remittance scheduling program 1323 completes all the process.

In addition, the program, which is equivalent to the remittance scheduling program 1323, executed on the ATM 11 starts when the scheduled remittance is selected from the menu screen (not shown). According to the program, which is equivalent to the remittance scheduling program 1323, executed on the ATM 11, the process in FIG. 2 is changed as follows. That is, the CPU 111 directly displays the screens on the display panel 113 at S001, S002, S005 and S006. Further, information input by the input device 114 is acquired at S002. Still further, the program requests the on-line banking server 13 to send an e-mail with the remittance certification or prints the remittance certification by the printer 116 at S007.

<Remittance Canceling Program>

The scheduled remittance is canceled when the account holder of the remittee account applies cancellation to the bank with which the bank account of the remitter is opened regardless of the bank with which the account holder of the remittee account is opened.

The remittance canceling program 1324 in the on-line banking server 13 starts when the HTTP request message from the user terminal 5 that is operated by the account holder of the remittee account specifies the URL of itself. Then, the first step S101 after the startup, the remittance canceling program 1324 executes a certification process. For example, the remittance canceling program 1324 requests that the remittance scheduling program 1323 sends the remittance certification when the remittance certification was directly transmitted to the account holder of the remittee account through an e-mail as the text data with the electronic signature. Further, when the remittance certification was printed, the remittance canceling program 1324 demands to input the information (the bank name with which the remittee account is opened, the branch name, the kind of account, the account number, the remitter name) recorded in the remittance certification and the code number of the remittee account. After the information is input, the program inquires of the bank with which the remittee account is opened whether the input code number is correct for the remittee account or not.

If the certification result at S101 was affirmed, at S102, the remittance canceling program 1324 inquires of the host 15 about the remittance schedule record corresponding to the information obtained at S101.

At the next step S103, the remittance canceling program 1324 sends an e-mail to inform the cancellation of the remittance to the remittee e-mail address included in the remittance schedule record responded from the host 15 at S102.

At the next step S104, the remittance canceling program 1324 request to cancel the scheduled remittance with respect to the remittance schedule record responded from the host 15 at S102. Finishing S104, the remittance canceling program 1324 completes all the processes.

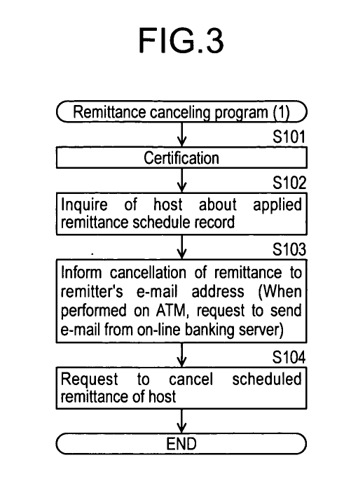

In addition, the program, which is equivalent to the remittance canceling program 1324, executed on the ATM 11 starts when the remittance cancellation is selected from the menu screen (not shown). According to the program, which is equivalent to the remittance canceling program 1324, executed on the ATM 11, the process in FIG. 3 is changed as follows. That is, the certification process at S101 is executed based on the information input on the input device 114. Further, the program requests that the on-line banking server 13 sends an e-mail informing the remittance cancellation at S103.

<Scheduled Remittance Management Program>

The scheduled remittance management program 1522 always runs and waits occurrence of a predetermined event at S201. When the ATM 11 or the remittance scheduling program 1323 of the on-line banking server 13 inquires about the withdrawable balance (S003), the scheduled remittance management program 1522 retrieves the withdrawable balance in the account balance record corresponding to the inquired bank account from the database 153 and returns it to the remittance scheduling program 1323 that inquired at S202. After completion of S202, the scheduled remittance management program 1522 returns the process to S201.

Further, when the ATM 11 or the remittance scheduling program 1323 of the on-line banking server 13 requests to store the remittance schedule record and to update the withdrawable balance (S008), the scheduled remittance management program 1522 advances the process from S201 to S203, creates a new remittance schedule record by editing the information (the information input into the scheduled remittance operation screen) received from the remittance scheduling program 1323, and stores it into the database 153. Still further, the scheduled remittance management program 1522 subtracts the amount corresponding to the remittance amount and the charge from the withdrawable balance in the account balance record corresponding to the bank account of the remitter (corresponding to the scheduling process). After completion of S203, the scheduled remittance management program 1522 returns the process to S201.

Further, when the ATM 11 or the remittance canceling program 1324 of the on-line banking server 13 inquires about the remittance schedule record (S102), the scheduled remittance management program 1522 advances the process from S201 to S204, retrieves the account balance record about the inquired bank account from the database 153 and responds to the remittance canceling program 1324 that inquired at S204. After completion of S204, the scheduled remittance management program 1522 returns the process to S201.

When the ATM 11 or the remittance canceling program 1324 of the on-line banking server 13 requests the cancellation of the scheduled remittance (S103), the scheduled remittance management program 1522 advances the process from S201 to S205, and adds the remittance amount and the charge of the requested scheduled remittance to the withdrawable balance in the account balance record corresponding to the account number in the requested remittance schedule record. At the next step S206, the scheduled remittance management program 1522 erases the remittance schedule record corresponding to the requested scheduled remittance from the hard disk drive 15 (corresponding to the canceling process). After completion of S206, the scheduled remittance management program 1522 returns the process to S201.

Further, the scheduled remittance management program 1522 advances the process from S201 to S207 at a predetermined batch process timing (just before operation start time in each business day) and extracts all the remittance schedule records whose remittance date matches the processing date from the database 15. At the next step S208, the scheduled remittance management program 1522 subtracts the amount corresponding to the remittance amount in the remittance schedule record and the charge from the balance in the account balance record whose account number is coincident with the account number in the remittance schedule record for the respective remittance schedule records extracted at S207 (corresponding to the remittance process). Then, the scheduled remittance management program 1522 executes a process that remits the money amount recorded as the remittance amount to the bank account indicated by the remittee ID in the remittance schedule record. Specifically, when the remittee ID indicates the bank account in the same bank, the money amount recorded as the remittance amount is added to the balance in the account balance record about the remittee account. On the other hand, when the remittee ID indicates the bank account in another bank, a telegram for remitting the money amount is sent to the host 15 of the remittee bank. After completion of S208, the scheduled remittance management program 1522 returns the process to S201.

(Procedures of Scheduled Remittance)

Hereinafter, procedures of scheduled remittance using the inter-bank remittance system of the embodiment as constructed above will be described in response to a specific example with reference to FIG. 7 through FIG. 12. In addition, this example is assumed that a contract for sale of a custom-made commodity is concluded between a buyer and a seller. Further, it is assumed that the bank account of the buyer is opened with the A bank and the bank account of the seller is opened with the B bank.

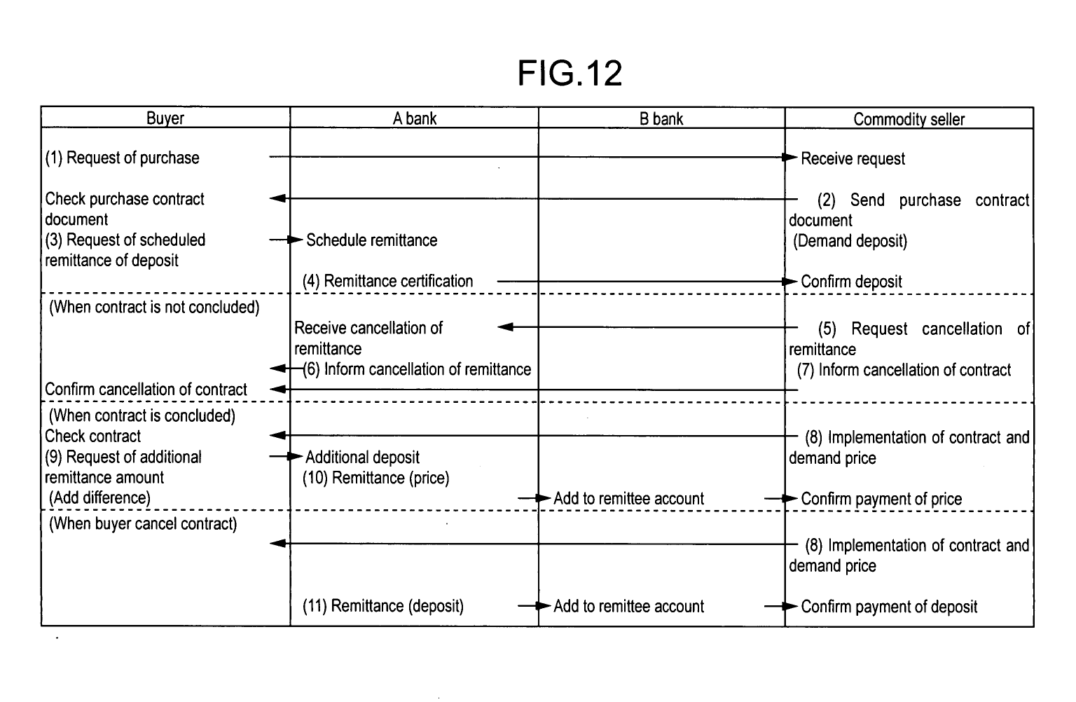

As shown in the sequence chart in FIG. 12, the buyer requests a purchase of a commodity from the commodity seller as the counterparty (1). Then, the commodity seller sends a purchase contract document to the buyer and the buyer checks the contents of the purchase contract document (2). In the purchase contract document, it is described that deposit of a part of the price is a precondition for a conclusion of the contract. Therefore, the buyer operates the ATM 11 or operates the user terminal 5 to access to the on-line banking server 13 and requests the scheduled remittance ((3), S001, S002). In addition, it is assumed that the date of the scheduled remittance is November 9 and the account balance record about the bank account of the buyer at the time is shown in FIG. 7.

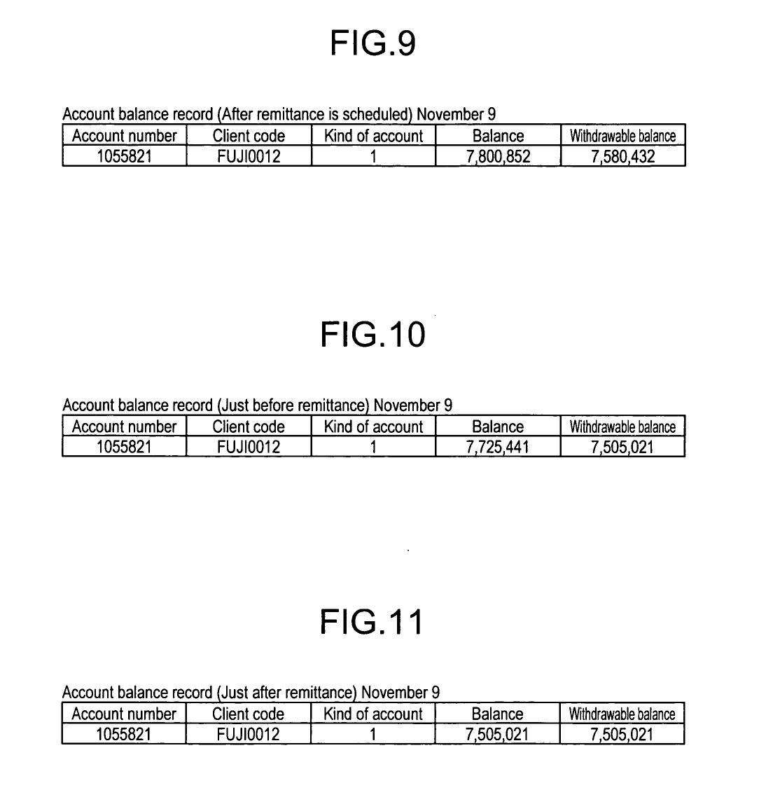

Receiving the request, the ATM 11 or the on-line banking server 13 of the A bank sends the remittance certification to the commodity seller through an e-mail (S007), thereby the commodity seller confirms the deposit of a part of the price (4). In addition, when the remittance certification is printed by the printer 116 of the ATM 11, the buyer mails the printed remittance certification to the commodity seller. Further, the host 15 of the A bank registers the remittance schedule record as shown in FIG. 8 into the database 153 and subtracts the remittance amount: ¥220,000 and the charge: ¥420 from the withdrawable balance in the account balance record corresponding to the bank account of the buyer (S008, S203). Then, the account balance record about the bank account of the buyer becomes as shown in FIG. 9 at the time.

After that, if the delivery of the commodity by the scheduled remittance date becomes impossible due to inevitability, the commodity seller operates the ATM 11 of the A bank or operates the user terminal 5 to access the on-line banking server 13 and applies the cancellation of the remittance ((5), S101). Then, the on-line banking server 13 of the A bank informs the buyer about the cancellation of the remittance through an e-mail ((6), S103). At the same time, the commodity seller mails a notice of cancellation of the contract to the buyer (7). As a result, the buyer can find the cancellation of the contract. Further, the host 15 of the A bank adds the remittance amount: ¥220,000 and the charge: ¥420 to the withdrawable balance in the account balance record about the bank account of the buyer (S205) and erases the remittance schedule record about the scheduled remittance from the database 153 (S206).

When the delivery of the commodity by the scheduled remittance date becomes possible, the commodity seller informs the implementation of the contract (a charge of remainder and a delivery of the commodity) to the buyer (8). Receiving the information, the buyer requests the A bank to remit the remainder to the bank account of the commodity seller according to the normal remittance procedure (9). After that, the host 15 of the A bank performs the scheduled remittance on the scheduled remittance date according to the remittance schedule record (10). As a result, the commodity seller can confirm that the total amount about the commodity has been remitted into his or her own bank account. Assuming that the account balance record about the bank account of the buyer just before the remittance is as shown in FIG. 10, the contents of the account balance record become as shown in FIG. 11 after the remittance according to the remittance schedule record of FIG. 8.

Even if the buyer cancels the contract after the implementation of the contract is informed to the buyer, since the buyer cannot cancel the scheduled remittance, the host 15 of the A bank performs the scheduled remittance on the scheduled remittance date according to the remittance schedule record (11). As a result, the commodity seller can confirm that the deposit can be collected.

### Embodiment 2

The second embodiment of the present invention is available when both of a bank system with which a user opens a bank account and a bank system with which a service provider or a commodity seller opens a bank account are improved. The second embodiment has a similar configuration to the first embodiment. However, the contents of the remittance scheduling program 1323, the remittance canceling program 1324 and the scheduled remittance management program 1522 are different from that in the first embodiment. Further, the A-bank system has the same construction elements as the B-bank system in the second embodiment.

(Contents of Process)

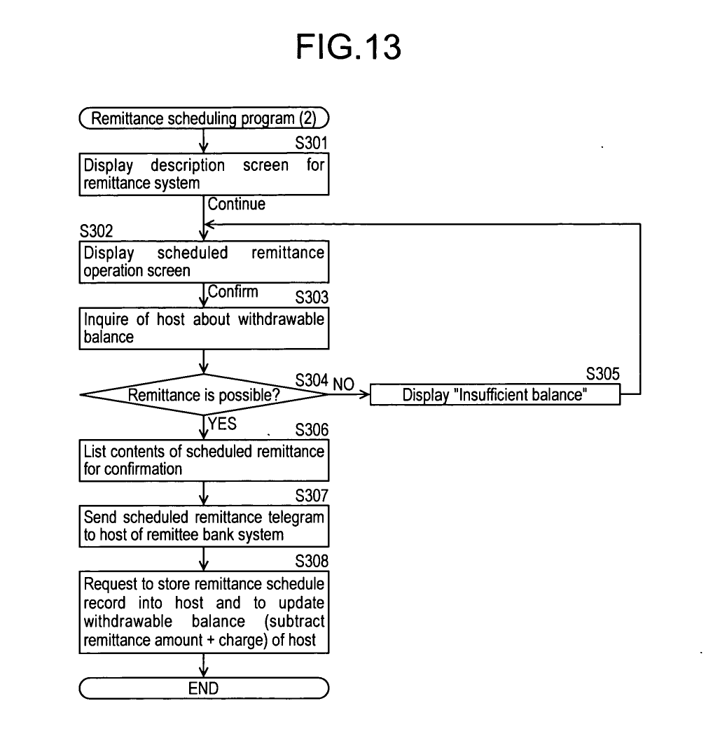

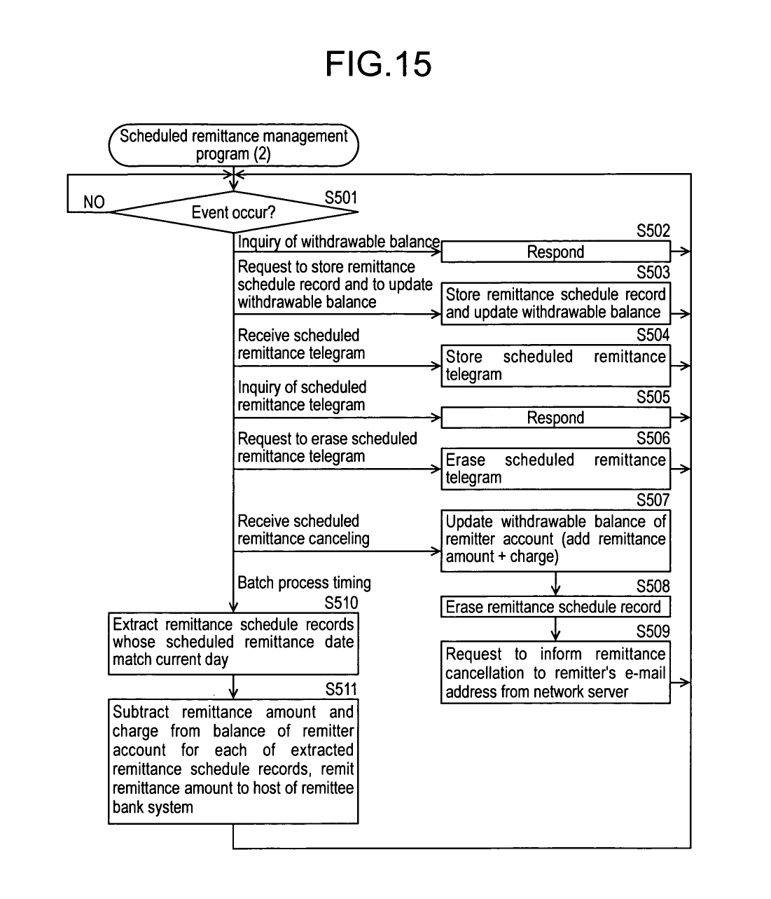

Contents of the remittance scheduling program 1323 and the remittance canceling program 1324 in the on-line banking server 13 and the scheduled remittance management program 1522 in the host 15, which are added to the respective bank systems 1 and 2 to perform the scheduled remittance method of the second embodiment of the present invention, will be described in order with reference to flowcharts in FIG. 13 through FIG. 15.

<Remittance Scheduling Program>

The remittance scheduling program 1323 in the on-line banking server 13 is started when an HTTP request message from the browser 51 of the user terminal 5 specifies the URL of itself. After startup, a process from S301 to S306 is identical with the process from S001 to S006 in FIG. 2 for the above described first embodiment.

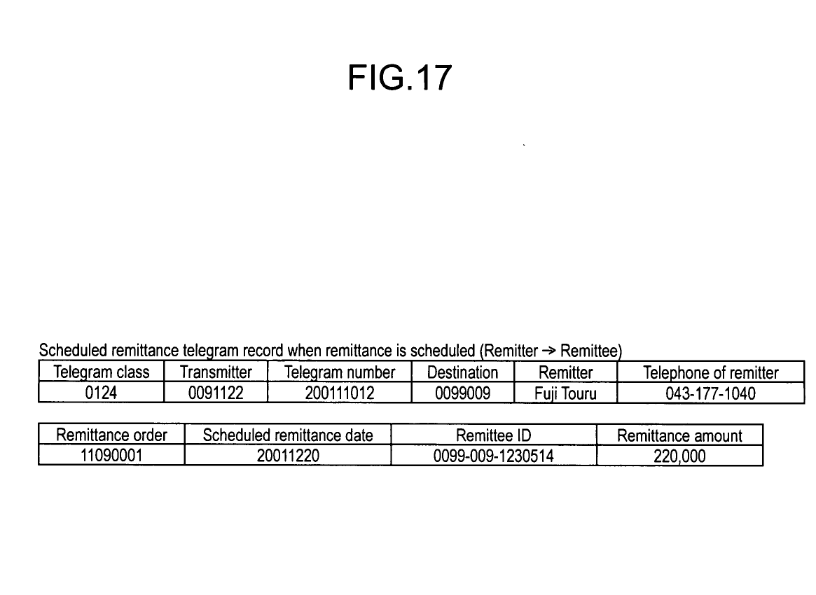

At the next step S307, the remittance scheduling program 1323 sends a scheduled remittance telegram record whose format is shown in FIG. 17 to the host 15 of the bank system that is indicated by the remittee bank name included in an HTTP request message received at S002 through the inter-bank network 3. As shown in FIG. 17, the scheduled remittance telegram record includes a telegram class to show that the telegram is a scheduled remittance telegram, a “transmitter” (a bank number+a branch number) to show a telegram transmitter office (a branch or a home office in which the on-line banking server 13 or the ATM 11 is installed), a telegram number that is a serial number to identify a telegram, a “destination” (a bank number+a branch number) to show a branch or a home office of the bank to which the telegram is transmitted, a name of a remitter, a telephone number of the remitter, a remittance order that is a serial number to identify a scheduled remittance, a scheduled remittance date, a remittee ID (a bank number+a branch number+an account number) to identify the remittee bank account, a scheduled remittance amount.

At the next step S308, the remittance scheduling program 1323 informs the information included in the HTTP request message received at S302 to the host 15, and requests to store a remittance schedule record and to update the withdrawable balance in the account balance record corresponding to the bank account of the remitter. After finishing a process at S308, the remittance scheduling program 1323 completes all the process.

In addition, the program, which is equivalent to the remittance scheduling program 1323, executed on the ATM 11 starts when the scheduled remittance is selected from the menu screen (not shown). According to the program, which is equivalent to the remittance scheduling program 1323, executed on the ATM 11, the process in FIG. 13 is changed as follows. That is, the CPU 111 directly displays the screens on the display panel 113 at S301, S302, S305 and S306. Further, information input by the input device 114 is acquired at S302.

<Remittance Canceling Program>

The scheduled remittance is canceled when the account holder of the remittee account applies cancellation to the bank with which the bank account of the remitter is opened.

The remittance canceling program 1324 in the on-line banking server 13 starts when the HTTP request message from the user terminal 5 specifies the URL of itself. Then, the first step S101 after the startup, the remittance canceling program 1324 executes a certification process. For example, the remittance canceling program 1324 demands to input the account number and the code number of the bank account of the operator who operates the user terminal 5. If the input code number is correct for the account indicated by the input account number, the program 1324 determines that the certification was done.

If the certification result at S401 was affirmed, at S402, the remittance canceling program 1324 inquires of the host 15 of its own bank system about the scheduled remittance telegram record including the remittee ID that is coincident with the account number certificated at S401.

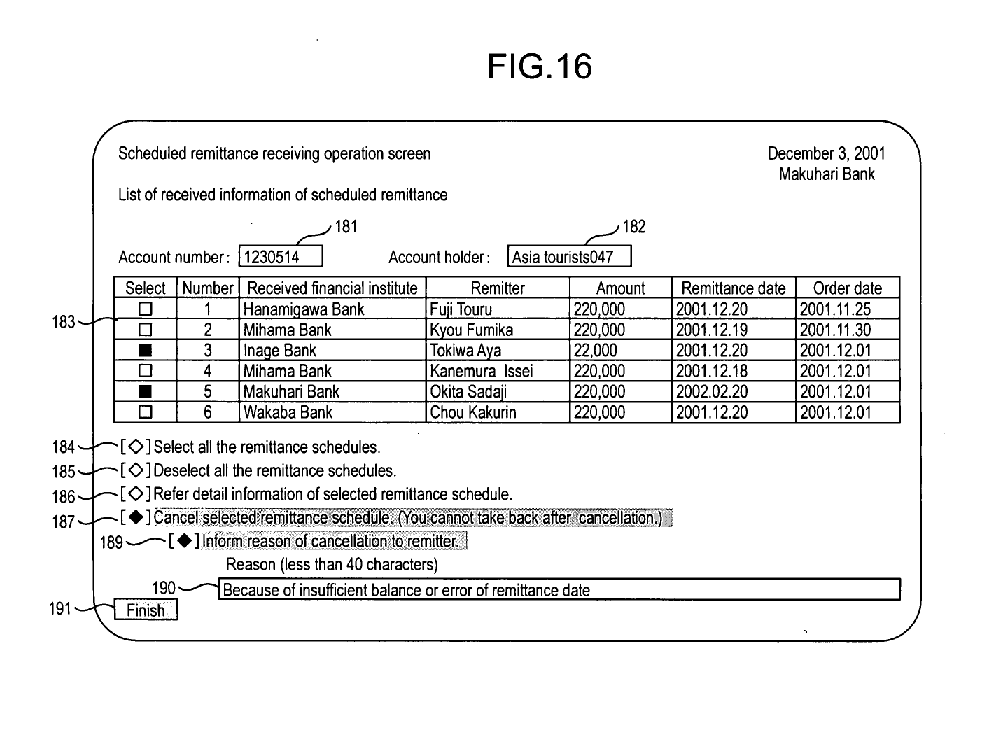

At the next step S403, the remittance canceling program 1324 sends HTML data for displaying a scheduled remittance receiving operation screen shown in FIG. 16 on the browser 51 to the user terminal 5 based on the scheduled remittance telegram records extracted from the records responded from the host 15 where the scheduled remittance date is latter than the processing date. The scheduled remittance operation screen includes a remittance scheduling table 183 that shows the contents of the respective scheduled remittance telegram records. The remittance scheduling table 183 includes a “selection” column indicating check boxes for selecting the scheduled remittance telegram record, a “number” column for indicating a consecutive number of the scheduled remittance telegram record, a “receiving financial institute” column for indicating a bank name corresponding to the “transmitter” in the scheduled remittance telegram record, a “remitter” column for indicating the “remitter”, an “amount of money” column for indicating the “remittance amount”, a “remittance date” column for indicating the “scheduled remittance date”, and an “order date” for indicating the timestamp for each of the scheduled remittance telegram records. Further, the scheduled remittance receiving screen includes a radio button 184 that is clicked for placing check marks in the check boxes of the “selection” column for all records in the remittance scheduling table 183 (selecting all the remittance schedules), a radio button 185 that is clicked for removing check marks in the check boxes of the “selection” column for all records in the remittance scheduling table 183 (deselecting all the remittance schedules), a radio button 187 that is clicked for canceling the scheduled remittance of the record where the check mark is placed in the check box in the “selection” column, a radio button 189 that is clicked for informing the reason of cancellation to the remitter of the canceled scheduled remittance, a “reason” column 190 for inputting the reason of cancellation that is informed to the remitter of the canceled scheduled remittance, and a “finish” button 191.

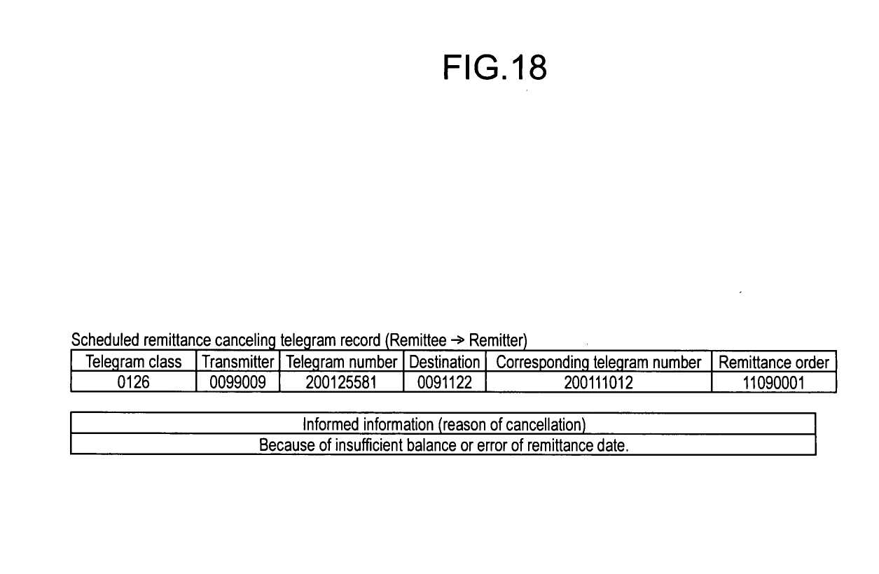

At the next step S404, the remittance canceling program 1324 checks whether the radio button 187 was clicked under the condition where a check mark was placed in a check box in the “selection” column of any of the records in the remittance scheduling table 183. When check marks were not placed in the check boxes in the “selection” column of any records or when the radio button 187 was not clicked, the remittance canceling program 1324 advances the process to S406. On the other hand, when the radio button 187 was clicked under the condition where a check mark was placed in a check box in the “selection” column of any of the records, the remittance canceling program 1324 requests to erase the scheduled remittance telegram record from the host 15 of its own bank system with respect to the scheduled remittance indicated by a record where a check mark is placed on the check box in the “selection” column and the program 1324 sends a scheduled remittance canceling telegram record whose format is shown in FIG. 18 to the host 15 of the bank displayed in the “receiving financial institute” column through the inter-bank network 3. The scheduled remittance canceling telegram record consists of, as shown in FIG. 18, a telegram class to show that the telegram is a scheduled remittance canceling telegram, a “transmitter” (a bank number+a branch number) to show a telegram transmitter office (a branch or a home office in which the on-line banking server 13 or the ATM 11 is installed), a telegram number that is a serial number to identify a telegram, a “destination” (a bank number+a branch number) to show a branch or a home office of the bank to which the telegram is transmitted, a “corresponding telegram number” and a “remittance order” that show the telegram number of the scheduled remittance telegram and the remittance order, respectively, corresponding to the scheduled remittance canceling telegram, and a “informed information” for showing the reason of cancellation input in the “reason” column 190 in the scheduled remittance receiving screen. Completing S405, the remittance canceling program 1324 advances the process to S406.

At S406, the remittance canceling program 1324 checks whether the “finish” button 191 in the scheduled remittance receiving screen was clicked or not. If the “finish” button 191 was not clicked, the process returns to S404. On the other hand, if the “finish” button 191 was clicked, the remittance canceling program 1324 finishes all the processes.

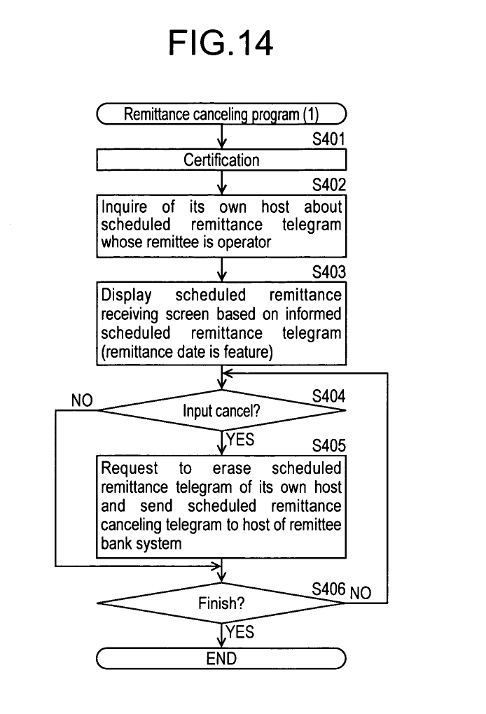

In addition, the program, which is equivalent to the remittance canceling program 1324, executed on the ATM 11 starts when the remittance cancellation is selected from the menu screen (not shown). According to the program, which is equivalent to the remittance canceling program 1324, executed on the ATM 11, the process in FIG. 14 is changed as follows. That is, the certification process at S401 is executed based on the information input on the input device 114. Further, the program requests that the on-line banking server 13 sends an e-mail informing the remittance cancellation at S403.

<Scheduled Remittance Management Program>

The scheduled remittance management program 1522 always runs and waits occurrence of a predetermined event at S501. When the ATM 11 or the remittance scheduling program 1323 of the on-line banking server 13 in its own bank system inquires about the withdrawable balance (S303), the scheduled remittance management program 1522 retrieves the withdrawable balance in the account balance record corresponding to the inquired bank account from the database 153 and returns it to the remittance scheduling program 1323 that inquired at S502. After completion of S502, the scheduled remittance management program 1522 returns the process to S501.

Further, when the ATM 11 or the remittance scheduling program 1323 of the on-line banking server 13 of its own bank system requests to store the remittance schedule record and to update the withdrawable balance (S308), the scheduled remittance management program 1522 advances the process from S501 to S503, creates anew remittance schedule record by editing the information (the information input into the scheduled remittance operation screen) received from the remittance scheduling program 1323, and stores it into the database 153. Still further, the scheduled remittance management program 1522 subtracts the amount corresponding to the remittance amount and the charge from the withdrawable balance in the account balance record corresponding to the bank account of the remitter (corresponding to the scheduling process). After completion of S503, the scheduled remittance management program 1522 returns the process to S501.

Further, when a scheduled remittance telegram record is received from the ATM 11 or the remittance canceling program 1324 of the on-line banking server 13 of another bank system (S307), the scheduled remittance management program 1522 advances the process from S501 to S504, and stores the received scheduled remittance telegram into the database 153. After completion of S504, the scheduled remittance management program 1522 returns the process to S501.

Still further, when the ATM 11 or the remittance canceling program 1324 of the on-line banking server 13 of its own bank system inquires about the scheduled remittance telegram record (S402), the scheduled remittance management program 1522 advances the process from S201 to S205, retrieves all the scheduled remittance telegram records about the inquired bank accounts from the database 153 and responds to the remittance canceling program 1324 that inquired. After completion of S505, the scheduled remittance management program 1522 returns the process to S501.

Yet further, when ATM 11 or the remittance canceling program 1324 of the on-line banking server 13 of its own bank system requests the erase of the scheduled remittance telegram record (S405), the scheduled remittance management program 1522 advances the process from S501 to S506, and erases the scheduled remittance telegram record requested to be erased from the database 153. After completion of S506, the scheduled remittance management program 1522 returns the process to S501.

When the scheduled remittance canceling telegram record is received from the ATM 11 or the remittance canceling program 1324 of the on-line banking server 13 of another bank system (S405), the scheduled remittance management program 1522 advances the process from S501 to S507, and adds the remittance amount and the charge of the requested scheduled remittance to the withdrawable balance in the account balance record corresponding to the account number in the remittance schedule record in response to the received scheduled remittance canceling telegram record. At the next step S508, the scheduled remittance management program 1522 erases the remittance schedule record from the hard disk drive 15 (equivalent to the canceling process). At the next step S509, the scheduled remittance management program 1522 request to send an e-mail informing the cancellation of remittance to the e-mail address of the account holder whose account number is in the erased remittance schedule record from the mail sending program 1325 of the on-line banking server 13. After completion of S509, the scheduled remittance management program 1522 returns the process to S501.

Further, the scheduled remittance management program 1522 advances the process from S501 to S510 at a predetermined batch process timing (just before operation start time in each business day) and extracts all the remittance schedule records whose remittance date matches the processing date from the database 15. At the next step S511, the scheduled remittance management program 1522 subtracts the amount corresponding to the remittance amount in the remittance schedule record and the charge from the balance in the account balance record whose account number is coincident with the account number in the remittance schedule record for the respective remittance schedule records extracted at S510. Then, the scheduled remittance management program 1522 executes a process that remits the money amount recorded as the remittance amount to the bank account indicated by the remittee ID in the remittance schedule record (corresponding to the remittance process). Specifically, when the remittee ID indicates the bank account in the same bank, the money amount recorded as the remittance amount is added to the balance in the account balance record about the remittee account. On the other hand, when the remittee ID indicates the bank account in another bank, a telegram for remitting the money amount is sent to the host 15 of the remittee bank. After completion of S511, the scheduled remittance management program 1522 returns the process to S501.

(Procedure of Scheduled Remittance)

Hereinafter, procedures of scheduled remittance using the inter-bank remittance system of the embodiment as constructed above will be described in response to a specific example with reference to FIG. 17 through FIG. 19. In addition, this example is assumed that a contract for sale of a custom-made commodity is concluded between a buyer and a seller. Further, it is assumed that the bank account of the buyer is opened with the A bank and the bank account of the seller is opened with the B bank.

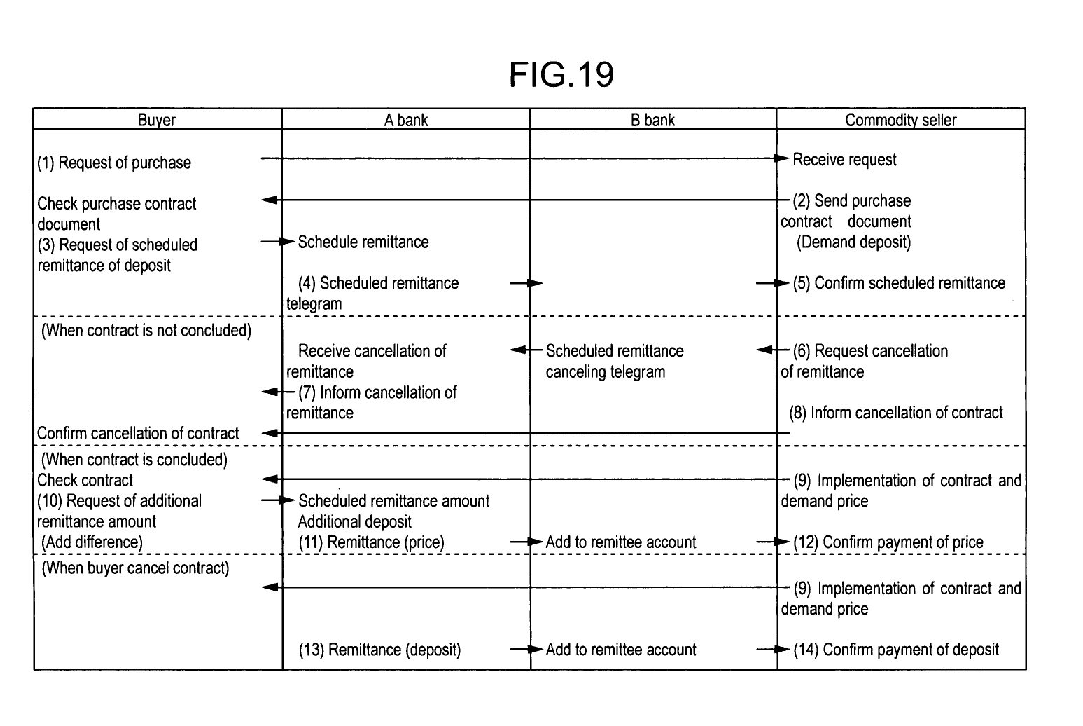

As shown in the sequence chart in FIG. 19, the buyer requests a purchase of a commodity from the commodity seller as the counterparty (1). Then, the commodity seller sends a purchase contract document to the buyer and the buyer checks the contents of the purchase contract document (2). In the purchase contract document, it is described that deposit of a part of the price is a precondition for a conclusion of the contract. Therefore, the buyer operates the ATM 11 or operates the user terminal 5 to access to the on-line banking server 13 and requests the scheduled remittance ((3), S301, S302).

Receiving the request, the ATM 11 or the on-line banking server 13 of the A bank requests that the host 15 of the A bank registers the remittance schedule record (S308) and sends the scheduled remittance telegram record to the host 15 of the B bank ((4), S307). The scheduled remittance telegram record shown in FIG. 17 is a sample when the contents of the remittance schedule record are coincident with that shown in FIG. 8. Since the scheduled remittance telegram record is received by the host 15 of the B bank, the commodity seller can confirm the contents of the scheduled remittance on the scheduled remittance receiving operation screen that is displayed by operating the ATM 11 of the B bank or the user terminal 5 to access to the on-line banking server 13 (5).

After that, if the delivery of the commodity by the scheduled remittance date becomes impossible due to inevitability, the commodity seller operates the ATM 11 of the A bank or operates the user terminal 5 to display the scheduled remittance receiving operation screen by accessing the on-line banking server 13, and applies the cancellation of the remittance regarding the contract on the scheduled remittance receiving operation screen ((6), S404). Then, the on-line banking server 13 or the ATM 11 of the B bank sends a scheduled remittance canceling telegram record for canceling the scheduled remittance to the host 15 of the A bank (S405). The scheduled remittance canceling telegram record shown in FIG. 18 is a sample when the contents of the scheduled remittance telegram record are coincident with that shown in FIG. 7. Receiving the scheduled remittance canceling telegram record, the host 15 of the A bank erases the remittance schedule record (S508) and informs the cancellation of remittance through an e-mail ((7), S509). At the same time, the commodity seller mails a notice of cancellation of the contract to the buyer (8). As a result, the buyer can find the cancellation of the contract.

When the delivery of the commodity by the scheduled remittance date becomes possible, the commodity seller informs the implementation of the contract (a charge of remainder and a delivery of the commodity) to the buyer (9). Receiving the information, the buyer requests the A bank to remit the remainder to the bank account of the commodity seller according to the normal remittance procedure (10). After that, the host 15 of the A bank performs the scheduled remittance on the scheduled remittance date according to the remittance schedule record (11). As a result, the commodity seller can confirm that the total amount about the commodity has been remitted into his or her own bank account (12).

Even if the buyer cancels the contract after the implementation of the contract is informed to the buyer, since the buyer cannot cancel the scheduled remittance, the host 15 of the A bank performs the scheduled remittance on the scheduled remittance date according to the remittance schedule record (13). As a result, the commodity seller can confirm that the deposit can be collected (14).

Availability on Industry

According to the above constructed scheduled remittance method of the present invention, the remittance from a bank account of a user to a bank account of a service provider or a commodity seller is stopped within a term from a conclusion of a contract to implementation thereof. Therefore, if the contract is canceled by a service provider or a commodity seller, unnecessary double remittance can be avoided and interest on the deposit is not paid to the bank account of the service provider of the commodity seller. Further, since the equivalent to the deposit is frozen in the user's bank account, there is guarantee that the deposit is reliably remitted to the bank account of the service provider or the commodity seller after a lapse of the term, which guarantees a credit of the user's solvency.

1. A scheduled remittance method comprising:
storing account balance records in a disk device to manage respective accounts, each of said account balance records including at least an ID of the account, balance of the account and withdrawable balance indicating an amount of money that can be withdrawn by an account holder;
executing scheduling process by a processing device, said scheduling process including;
storing remittance schedule records in said disk device at a request of a remitter, each of said remittance schedule records consisting of an ID of a remitter account, a scheduled remittance date, an amount of remittance and an ID of a remittee account, and
subtracting the amount of remittance from the withdrawable balance in said account balance record corresponding to the remitter account,
executing remittance process by said processing device for subtracting the amount of remittance from the balance in the account balance record corresponding to the remitter account to remit the amount of the remittance to the remittee account based on the remittance schedule record whose remittance date matches the processing date.

2. The scheduled remittance method according to claim 1, further comprising:
executing a canceling process by said processing device, said canceling process including:
voiding the remittance schedule record only when a account holder of the remittee account in the remittance schedule record demands to void; and
adding the amount of remittance in the remittance schedule record to the withdrawable balance in the account balance record corresponding to the ID of the remitter account in the remittance schedule record.

3. The scheduled remittance method according to claim 1 or 2, wherein a remitter account and a remittee account in any of said remittance schedule records are opened with different financial institutes, respectively, and wherein said disk device and said processing device exist in a system of a financial institute with which said remitter account is opened.

4. The scheduled remittance method according to claim 1 or 2, wherein said processing device informs the contents of said remittance schedule record to the account holder of said remittee account when said scheduling process is executed.

5. The scheduled remittance method according to claim 1, wherein a remitter account and a remittee account in any of said remittance schedule records are opened with different financial institutes, respectively, said disk device and said processing device exist in a system of a financial institute with which said remitter account is opened, and wherein said processing device informs the contents of said remittance schedule record to the financial institute with which said remittee account is opened when said scheduling process is executed.

6. The scheduled remittance method according to claim 5, wherein the contents of said informed remittance schedule record are stored in said disk device in the system of the financial institute to which the contents of said remittance schedule record were informed, and wherein said processing device executes a process for displaying the contents of said remittance schedule record at the request from the account holder of said remittee account.

7. The scheduled remittance method according to claim 2, wherein a remitter account and a remittee account in any of said remittance schedule records are opened with different financial institutes, respectively, said disk device and said processing device exist in a system of a financial institute with which said remitter account is opened, said processing device informs the contents of said remittance schedule record to the financial institute with which said remittee account is opened when said scheduling process is executed, the contents of said informed remittance schedule record are stored in said disk device in the system of the financial institute to which the contents of said remittance schedule record were informed, and wherein said processing device executes a process for informing that said remittance schedule record becomes void at the request of the account holder of said remittee account to the financial institute with which said remitter account is opened.

8. A scheduled remittance management program running on a computer that is connected to a disk device storing account balance records in a disk device to manage respective accounts, each of said account balance records including at least an ID of the account, balance of the account and withdrawable balance indicating an amount of money that can be withdrawn by an account holder, said program comprising:
a scheduling process for storing remittance schedule records in said disk device at a request of a remitter, each of said remittance schedule records consisting of an ID of a remitter account, a scheduled remittance date, an amount of remittance and an ID of a remittee account, and for subtracting the amount of remittance from the withdrawable balance in said account balance record corresponding to the remitter account; and
a remittance process for for subtracting the amount of remittance from the balance in the account balance record corresponding to the remitter account to remit the amount of the remittance to the remittee account based on the remittance schedule record whose remittance date matches the processing date.

9. A computer-readable recording medium that storing A scheduled remittance management program running on a computer that is connected to a disk device storing account balance records in a disk device to manage respective accounts, each of said account balance records including at least an ID of the account, balance of the account and withdrawable balance indicating an amount of money that can be withdrawn by an account holder, said program comprising:
a scheduling process for storing remittance schedule records in said disk device at a request of a remitter, each of said remittance schedule records consisting of an ID of a remitter account, a scheduled remittance date, an amount of remittance and an ID of a remittee account, and for subtracting the amount of remittance from the withdrawable balance in said account balance record corresponding to the remitter account; and
a remittance process for for subtracting the amount of remittance from the balance in the account balance record corresponding to the remitter account to remit the amount of the remittance to the remittee account based on the remittance schedule record whose remittance date matches the processing date.
